(19) United States
(12) Patent Application Publication
(10) Pub. No.: US 2013/0213250 A1
(43) Pub. Date: Aug. 22, 2013

(54) PRINTING BLANKET UNIT

(71) Applicant: ContiTech Elastomer-Beschichtungen GmbH, (US)

(72) Inventors: Stefan Fuellgraf, Duderstadt (DE); Markus Gnass, Osterode (DE)

(73) Assignee: ContiTech Elastomer-Beschichtungen GmbH, Hannover (DE)

(21) Appl. No.: 13/852,814

(22) Filed: Mar. 28, 2013

Related U.S. Application Data
(63) Continuation of application No. PCT/EP2011/064017, filed on Aug. 15, 2011.

(30) Foreign Application Priority Data
Sep. 29, 2010 (DE) 10 2010 037 865.8

(51) Int. Cl. B41N 10/02

(52) U.S. Cl. CPC B41N 10/02
USPC 101/401.1

(57) ABSTRACT

A printing blanket unit for a printing blanket cylinder of a rotary printing press includes a printing blanket defining a transverse direction and having two mutually parallel side edges extending in the transverse direction. One of the side edges defines a leading side edge and the other one of the side edges defines a trailing side edge referred to the rotation of the printing blanket cylinder. The printing blanket has a top side and defines a longitudinal direction running perpendicular to the transverse direction. The top side of the printing blanket has a groove therein running in the longitudinal direction of the printing blanket.

### CROSS REFERENCE TO RELATED APPLICATIONS

This application is a continuation application of international patent application PCT/EP2011/064017, filed Aug. 15, 2011, designating the United States and claiming priority from German application 10 2010 037 865.8, filed Sep. 29, 2010, and the entire content of both applications is incorporated herein by reference.

### FIELD OF THE INVENTION

The invention relates to a printing blanket unit for a printing blanket cylinder of a rotary printing press. The printing blanket unit has a printing blanket with two parallel side edges which extend in a transverse direction of the printing blanket. These edges lie opposite one another and one forms a leading side edge and the other forms a trailing side edge viewed in the direction of rotation of the printing blanket cylinder.

### BACKGROUND OF THE INVENTION

A printing blanket unit of this type is used in a rotary printing press, in particular, in waterless offset printing which is used, for example, during the printing of daily newspapers or magazines.

In a rotary printing press of this type, the actual printing plate is arranged on a plate cylinder, on which printing plate a positive image of the page to be printed is situated. An inking roll is in contact with the plate cylinder in such a way that the printing ink is transferred from the inking roll onto the plate cylinder or the printing plate which is situated on it. The ink is transferred from the printing plate on the plate cylinder onto a printing blanket which is situated on a printing blanket cylinder which is in contact with the plate cylinder. A negative image of the newspaper page to be printed is therefore produced on the printing blanket. The printing blanket which is provided with ink in this way is subsequently rolled on the paper web to be printed, with the result that a positive image of the newspaper page to be printed is produced on the paper web.

A printing blanket has a transverse direction and a longitudinal direction which extends perpendicularly with respect to said transverse direction. If the printing blanket is fastened on the printing blanket cylinder, the side edges which extend in the transverse direction of the printing blanket extend in the axial direction and therefore form a leading and a trailing side edge with regard to the rotation of the printing blanket cylinder. The two side edges of the printing blanket which extend in the longitudinal direction of the printing blanket extend in the circumferential direction of the printing blanket cylinder. Here, the extent of the printing blanket in the longitudinal direction corresponds to the circumference of the printing blanket cylinder and to a multiple of the page length to be printed. Here, the extent of the printing blanket in the transverse direction, that is to say the width of the printing blanket, corresponds to a multiple of the page width to be printed.

In newspaper printing, a distinction is made between what are known as single plates, by way of which individual newspaper pages can be printed, and what are known as panorama plates, by way of which in each case double pages of the newspaper to be printed can be printed. The latter are used, in particular, in the case of large images or picture galleries when the entire width of a double page of the newspaper is to be utilized. Whereas the central region of a double page is to be printed in the case of the printing of panorama pages, this is to be avoided as far as possible in the case of the printing of single pages. In this case, as far as possible no printing ink is to pass in the center of a double page onto the paper to be printed. In the case of the printing of a panorama page, a panorama plate which is to be inked with the printing ink over the entire width is situated on the plate cylinder.

A plurality of printing plates are usually arranged next to one another on a plate cylinder. Here, the region between the pages to be printed is as far as possible not to be inked with printing ink, in order to avoid the disruptive formation of stripes in the later newspaper. This is usually achieved by the inking roll, by way of which the printing ink is transferred onto the plate cylinder, having grooves which extend in the circumferential direction. Said grooves are arranged precisely where the plate cylinder or the printing plates which are situated on it are not to be provided with printing ink. During the exchange of the printing plates, it can then occur that a panorama printing plate for printing panorama pages is to be replaced by a single plate for printing single pages. The region between the two single pages to be printed, which region still has to be inked with printing ink in the case of a panorama plate, is then to be kept largely free of printing ink. This means that the inking roll requires a further groove which extends in the circumferential direction at the location between the single pages to be printed which lie next to one another. The inking roll therefore has to be exchanged for a corresponding additional inking roll which has the grooves at the desired locations.

A plurality of printing plates are usually situated next to one another on a plate cylinder. It is thus possible, for example, to arrange four panorama plates for printing different panorama pages on the plate cylinder at the same time. The panorama plates then lie on the plate cylinder, for example, in two rows of two which are arranged above one another, that is, next to one another in the circumferential direction of the plate cylinder. As a result, eight newspaper pages can be printed. This can also be carried out with eight single plates, of which in each case two can replace one panorama plate. If further pages of the newspaper to be printed are printed later by way of the rotary printing press, the printing plates are exchanged for new printing plates. Here, a single panorama printing plate, more than one or all of the panorama printing plates can be replaced by single printing plates. Many different possible combinations of panorama and/or single printing plates which are arranged next to one another are therefore produced. For each of the possible combinations, the associated inking roll has to have a groove at the locations, at which the plate cylinder is not to be inked. It is therefore necessary to provide a plurality of different inking rolls. As a result, the rotary printing process becomes expensive and space-intensive, since the different inking rolls possibly have to be stored intermediately for a plurality of different printing inks, if the inking rolls are not currently being used in the rotary printing press. In addition, the exchange of inking rolls is relatively time-consuming. The rotary printing press cannot be used for printing during this period. As a result, the production of the newspaper to be printed becomes expensive.

### SUMMARY OF THE INVENTION

In view of the above, it is an object of the invention to reduce or completely eliminate the above disadvantage.

The invention achieves the stated object by way of a printing blanket unit for a printing blanket cylinder of a rotary printing press. The printing blanket unit has a printing blanket with two parallel side edges which extend in a transverse direction of the printing blanket, lie opposite one another, and of which one forms a leading side edge and one forms a trailing side edge with regard to a rotation of the printing blanket cylinder. The printing blanket unit is distinguished by the fact that an upper side of the printing blanket has at least one first groove which extends in a longitudinal direction of the printing blanket, which longitudinal direction extends perpendicularly with respect to the transverse direction.

If two single pages are then to be printed next to one another, a printing blanket unit of this type is arranged on the printing blanket cylinder of the rotary printing press. No ink can be transferred from the plate cylinder or the printing plate which is fastened to it onto the printing blanket unit or its printing blanket at the location where the at least one first groove extends which extends in this state in the circumferential direction of the printing blanket cylinder of the rotary printing press. During the printing of the two single pages by way of the printing blanket of the printing blanket unit according to the invention, an ink transfer onto the paper web to be printed therefore cannot occur between the two single pages even though the corresponding printing plate on the plate cylinder is inked with printing ink at the corresponding location. As a result, the at least one first groove advantageously always extends where an ink transfer onto the paper to be printed is to be avoided.

Here, it has proved to be particularly advantageous if the at least one first groove is arranged in a central region of the printing blanket. In particular, if the extent of the printing blanket or the printing blanket unit in the transverse direction corresponds to two times a single page to be printed, the region between the two single pages on the paper web can be kept free of printing ink in this way.

In one preferred embodiment, the at least one first groove extends from the leading side edge as far as the trailing side edge. It is ensured in this way that no printing ink passes between two pages to be printed over the entire length of the paper web to be printed.

The extent of the printing blanket unit in the transverse direction of course does not necessarily have to correspond to two times a single page to be printed. However, it advantageously corresponds to an integral multiple of this width. A plurality of grooves are then provided which are then always situated between two pages to be printed. These pages can then be both single and panorama pages. However, it has proved advantageous if the extent of the printing blanket unit in the transverse direction corresponds to exactly the width of a panorama page. A plurality of printing blanket units can be arranged on the printing blanket cylinder of the rotary printing press. In this way, a gap is produced between in each case two printing blanket units. This gap likewise prevents that printing ink is transmitted from the plate cylinder onto the paper web to be printed. In this way, a single printing blanket unit can be replaced quickly and simply if a changeover is to be carried out from the printing of a panorama page to the printing of two single pages which lie next to one another.

Only a single inking roll has to be provided as a result of a printing blanket unit having at least one first groove which extends in the longitudinal direction of the printing blanket. As a result, both costs for the additional inking rolls are saved and the required storage space is reduced. In addition, a printing blanket unit can be changed substantially more simply, more rapidly and less expensively than an inking roll. The single inking roll which is then to be used in a rotary printing press then either has to have absolutely no more grooves in the circumferential direction or can have grooves, the spacing of which is a multiple of the width of a panorama page to be printed. If the spacing between two grooves in the circumferential direction on the inking roll corresponds exactly to the width of a panorama page, no ink is transferred onto the plate cylinder and therefore also not onto the printing blanket cylinder between two panorama pages to be printed. This ink which otherwise would not be transferred onto the paper to be printed anyway can thus be saved. As a result, the production costs and material costs of the newspaper are reduced further.

The upper side of the printing blanket advantageously has at least one second groove which extends in the transverse direction of the printing blanket. If the printing blanket unit is situated on the printing blanket cylinder, a groove of this type does not extend in the circumferential direction as a result, as in the at least one first groove, but rather in the axial direction of the printing blanket cylinder. This is appropriate, in particular, when the circumference of the printing blanket cylinder corresponds to a multiple of the height of the page to be printed. This ensures that no printing ink likewise passes onto the paper web to be printed between two newspaper pages to be printed above one another.

The at least one first groove has a width of at least 6 mm, preferably at least 8 mm, particularly preferably at least 10 mm and at most 15 mm, preferably at most 13 mm, particularly preferably at most 12 mm. The at least one first groove has a depth of at least 0.1 mm, preferably at least 0.2 mm, preferably at least 0.4 mm and at most 1.0 mm, preferably at most 0.7 mm, particularly preferably at most 0.5 mm. In particular, a width of 12 mm corresponds to the roll groove width. A printing blanket of a printing blanket unit can consist of a plurality of, optionally different, rubber layers which are arranged above one another. In the case of a depth of the at least one first groove of, for example, 0.2 nm, this depth corresponds to, for example, the thickness of the uppermost rubber layer of the printing blanket. Here, the groove can be produced, for example, by milling out of the uppermost rubber layer, or can already be provided during the application of the last rubber layer. In this case, the last rubber layer would not be applied at the location, at which the groove is to be situated later. The upper edges of the at least one first groove are preferably rounded or beveled at a transition of the groove to the upper side of the printing blanket. Here, the upper edges of the at least one first groove form the transition between side walls of the groove and the upper side of the printing blanket. During the printing of a newspaper, the printing ink which is transferred from the printing plate onto the printing blanket is transferred onto the paper web to be printed. Here, the printing blanket which consists, for example, of a plurality of rubber layers is compressed greatly. As a result of the fact that the upper edges of the at least one first groove are rounded or beveled, the stability of this groove is increased, and therefore the service life and the durability of the printing blanket unit or the printing blanket is increased.

It has proved advantageous if the lower edges of the at least one first groove are rounded at a transition of the groove to a groove bottom. Here, the lower edges of a first groove form the transition from the side walls of the groove to the groove bottom of the groove. As a result of the rounding of said edges, firstly the production process is simplified, since a shape of this type of the groove can be produced more simply by being milled out of the upper side of the printing blanket. In addition, the stability of the groove and therefore of the printing blanket is increased.

The printing blanket is advantageously arranged with a lower side which lies opposite the upper side on a dimensionally stable carrier plate. The latter can be, for example, a thin steel sheet, by way of which the printing blanket unit is fixed on the printing blanket cylinder.

### BRIEF DESCRIPTION OF THE DRAWINGS

The invention will now be described with reference to the drawings wherein:

FIG. 1 is a schematic plan view of a printing blanket unit according to a first embodiment of the invention;

FIG. 2 is a schematic plan view of a printing blanket unit according to a second embodiment of the invention; and,

FIG. 3 is an enlarged detail section view along line III-III of FIG. 1 showing the groove in the printing blanket of the printing blanket unit according to one embodiment of the invention.

### DESCRIPTION OF THE PREFERRED EMBODIMENTS OF THE INVENTION

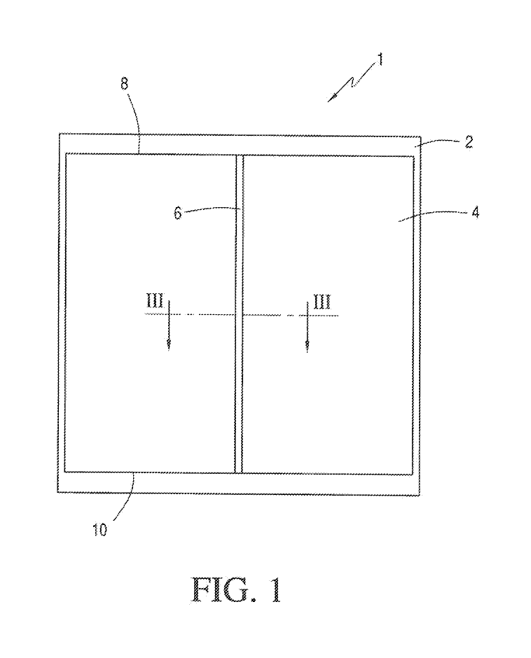

FIG. 1 shows a diagrammatic plan view of a printing blanket unit 1 according to a first embodiment of the invention. A printing blanket 4 is arranged on a carrier plate 2. The printing blanket 4 has a first groove 6 in the embodiment shown in FIG. 1. The printing blanket 4 has two parallel side edges, of which one forms a leading side edge 8 and one forms a trailing side edge 10. The leading side edge 8 and the trailing side edge 10 extend in the transverse direction of the printing blanket, whereas the first groove 6 extends in the longitudinal direction of the printing blanket. If a printing blanket unit 1 of this type is fastened to a printing blanket cylinder (not shown), the parts of the carrier plate 2 which project beyond the printing blanket 4 at the top and bottom in FIG. 1 are fastened, for example, to the printing blanket cylinder.

The first groove 6 then extends in the circumferential direction of the printing blanket cylinder, whereas the leading side edge 8 and the trailing side edge 10 extend in the axial direction of the printing blanket cylinder of the rotary printing press. An upper side 12 of the printing blanket 4 is divided by the first groove 6 into two parts which are equal in size in the embodiment shown in FIG. 1. Both parts can correspond, for example, to the size of a single page, with the result that two single pages which lie next to one another can be printed by way of a printing blanket 4 (shown in FIG. 1) of a printing blanket unit 1. No ink can be transferred from a printing plate on a plate cylinder onto the printing blanket 4 at the location where the first groove 6 extends, with the result that no ink can be transferred from the printing blanket 4 onto a paper web to be printed either. The region between the two single pages to be printed therefore remains free of printing ink.

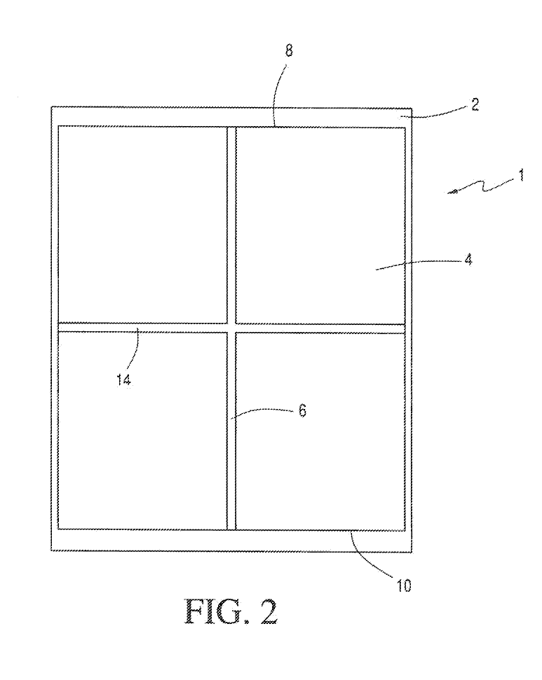

FIG. 2 shows a diagrammatic plan view of a printing blanket unit 1 according to a further embodiment of the invention. The printing blanket unit 1 of FIG. 2 also has a carrier plate 2, on which a printing blanket 4 is arranged. The printing blanket unit 1 which is shown in FIG. 2 differs from the printing blanket unit 1 which is shown in FIG. 1 because of a second groove 14 which extends perpendicularly with respect to the first groove 6. Like the leading side edge 8 and the trailing side edge 10, the second groove 14 extends in the axial direction of a printing blanket cylinder if the printing blanket unit 1 is arranged on the printing blanket cylinder of a rotary printing press. An upper side 12 of the printing blanket 4 is divided into four parts by the first groove 6 and the second groove 14. The parts are of equal size in the embodiment which is shown in FIG. 2. They correspond, for example, to the size of an individual single page to be printed. Four single pages can therefore be printed at the same time by way of the printing blanket 4 (shown in FIG. 2) of the printing blanket unit 1. The first groove 6 and the second groove 14 ensure that the region between the single pages to be printed on the paper web to be printed remains free of printing ink.

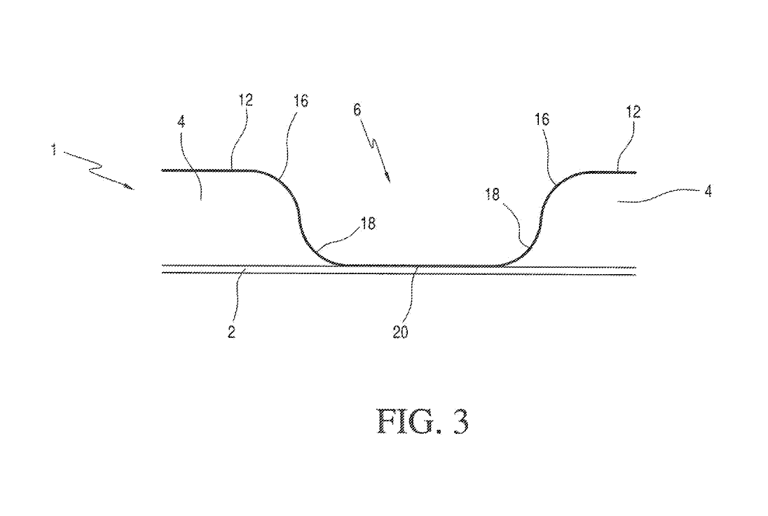

FIG. 3 shows an enlarged detail of a cross section through a printing blanket unit 1 groove 6 along section line III-III of FIG. 1. A printing blanket 4 is arranged on a carrier plate 2. The printing blanket 4 has a first groove 6. FIG. 3 shows that both the upper edges 16 and the lower edges 18 of the first groove 6 are rounded. Here, an upper edge 16 forms the transition from an upper side 12 of the printing blanket 4 to a side wall of the first groove 6. A lower edge 18 forms the transition from the side wall of the first groove 6 to a groove bottom 20 of the first groove 6.

During printing with a printing blanket unit 1, as is shown in detail in FIG. 3, the printing blanket 4 is compressed greatly from above in the arrangement which is shown in FIG. 3. As a result of the fact that both the upper edges 16 and the lower edges 18 are rounded, the risk of the edges (16, 18) crumbling or breaking off is reduced, with the result that the printing blanket unit 1 and the printing blanket 4 can be used for a longer time.

It is understood that the foregoing description is that of the preferred embodiments of the invention and that various changes and modifications may be made thereto without departing from the spirit and scope of the invention as defined in the appended claims.

### LIST OF DESIGNATIONS

1 Printing blanket unit
2 Carrier plate
4 Printing blanket
6 First groove
8 Leading side edge
10 Trailing side edge
12 Upper side
14 Second groove
16 Upper edge
18 Lower edge
20 Groove bottom

What is claimed is:

1. A printing blanket unit for a printing blanket cylinder of a rotary printing press, the printing blanket cylinder being rotatably mounted for rotation about a rotational axis, the printing blanket unit comprising:
a printing blanket defining a transverse direction and having two mutually parallel side edges extending in said transverse direction;
one of said side edges defining a leading side edge and the other one of said side edges defining a trailing side edge referred to said rotation of said printing blanket cylinder;
said printing blanket having a top side and defining a longitudinal direction running perpendicular to said transverse direction; and,
said top side of said printing blanket having a groove therein running in said longitudinal direction of said printing blanket.

2. The printing blanket of claim 1, wherein said groove is arranged in a mid-region of said printing blanket.

3. The printing blanket of claim 1, wherein said groove extends from said leading side edge to said trailing side edge.

4. The printing blanket of claim 1, wherein said groove is a first groove and said printing blanket has a second groove extending in said transverse direction of said printing blanket.

5. The printing blanket of claim 1, wherein said groove has a width of at least 6 mm.

6. The printing blanket of claim 1, wherein said groove has a width of at least 8 mm.

7. The printing blanket of claim 1, wherein said groove has a width of at least 10 mm.

8. The printing blanket of claim 1, wherein said groove has a width of at most 15 mm.

9. The printing blanket of claim 1, wherein said groove has a width of at most 13 mm.

10. The printing blanket of claim 1, wherein said groove has a width of at most 12 mm.

11. The printing blanket of claim 1, wherein said groove has a depth of at least 0.1 mm.

12. The printing blanket of claim 1, wherein said groove has a depth of at least 0.2 mm.

13. The printing blanket of claim 1, wherein said groove has a depth of at least 0.4 mm.

14. The printing blanket of claim 1, wherein said groove has a depth of at most 1.0 mm.

15. The printing blanket of claim 1, wherein said groove has a depth of at most 0.7 mm.

16. The printing blanket of claim 1, wherein said groove has a depth of at most 0.5 mm.

17. The printing blanket of claim 1, wherein said groove has mutually adjacent side walls which transition to said top side of said printing blanket at respective upper groove edges; and, said upper groove edges are rounded or beveled.

18. The printing blanket of claim 17, wherein said groove has a base wall; said side walls of said groove transition to said base wall at respective lower groove edges; and, said lower groove edges are rounded.

19. The printing blanket of claim 1, further comprising a dimensionally stable carrier plate; said printing blanket having a bottom side lying opposite said top side thereof; and, said printing blanket being arranged with said bottom side thereof on said dimensionally stable carrier plate.
